(19) United States
(12) Patent Application Publication
(10) Pub. No.: US 2021/0399574 A1
(43) Pub. Date: Dec. 23, 2021

(54) REMOTELY CONTROLLED POWER SWITCHING MODULE

(71) Applicant: Metra Electronics Corporation, Holly Hill, FL (US)

(72) Inventors: Daniel C. Wiggins, Holly Hill, FL (US); Thomas E. Burgess, Holly Hill, FL (US); Benjamin Webster, Holly Hill, FL (US)

(73) Assignee: Metra Electronics Corporation, Holly Hill, FL (US)

(21) Appl. No.: 17/350,446

(22) Filed: Jun. 17, 2021

Related U.S. Application Data
(60) Provisional application No. 63/040,710, filed on Jun. 18, 2020.

(51) Int. Cl. H02J 13/00; H02J 3/14; H01R 13/66

(52) U.S. Cl. CPC H02J 13/00022; H01R 13/665; H02J 13/00032; H02J 3/14

(57) ABSTRACT

A remotely controlled switching module that provides switching and preferably dimming functions for one or more AC or DC power distribution lines. The inventive module is preferably sized to fit within existing outlet and switch boxes, while still leaving enough room for the conventional components that are also housed in such enclosures. Remote control is provided wirelessly—preferably using an existing wireless communication protocol. Local control is preferably also provided for the inventive switching module. Local control inputs preferably allow control via existing components—such as two-pole light switches.

### CROSS-REFERENCES TO RELATED APPLICATIONS

This non-provisional patent application claims the benefit of U.S. Pat. App. Ser. No. 63/040,701. The parent application was filed on Jun. 18, 2020. It listed the same inventors.

### STATEMENT REGARDING FEDERALLY SPONSORED RESEARCH OR DEVELOPMENT

Not applicable

### MICROFICHE APPENDIX

Not applicable

### BACKGROUND OF THE INVENTION

### 1. Field of the Invention

This invention relates to the field of electrical power control and monitoring. More specifically, the invention comprises a control module that can switch one or more electrical power lines according to remote inputs and possibly local inputs as well.

### 2. Description of the Related Art

The present invention can be configured for use with many different types of electrical power distribution systems. It has been developed primarily for use in the final stage of electrical power distribution (generally understood to be the distribution of electrical power from a circuit breaker box to various loads). However, the invention can also be used for other purposes such as the switching of three-phase AC power and the switching of DC power. The embodiments provided in this disclosure should thus be viewed as exemplary. Many more applications will occur to those knowledgeable in the field, and it is impractical to attempt to illustrate each and every one of these applications.

The “smart home” concept has evolved rapidly in recent years. In this paradigm electrical receptacles and switches can be remotely controlled. As an example, a line of “smart” switches and receptacles are marketed by the Leviton Manufacturing Co., Inc., of 201 North Service Road, Melville, N.Y., U.S.A. These devices can be centrally controlled by a programmable processor. They can also provide certain power consumption monitoring functions. Similar products are offered by other manufacturers.

The “smart home” devices require the installation of “smart” switches and receptacles. These components are quite expensive in comparison to the conventional components they replace. In some cases additional control wiring must also be run. The installation burden for new construction is not overwhelming. However, the owner of an existing structure may not wish to endure the expense of removing every outlet and switch and replacing them with “smart” components.

The “smart home” systems have also traditionally employed a dedicated control system. If—for example—a user selects the previously-mentioned Leviton system, then the user must install a Leviton control system. In recent years, however, wireless control systems that are potentially independent of the hardware have emerged. A good example is the “ALEXA” virtual assistant marketed by Amazon, Inc., of Seattle, Wash., U.S.A. The ALEXA device interacts wirelessly with a wide range of external components. The ALEXA device is also user-configurable. Thus, a user can configure an ALEXA device to control other products around a home or office.

There presently exists a need to add “smart home” functionality to existing electrical distribution components. Suitable control systems already exist—such as the ALEXA device. The present invention presents a solution to this need, as well as a solution to many other needs.

### BRIEF SUMMARY OF THE PRESENT INVENTION

The present invention comprises a remotely controlled switching module that provides switching and preferably dimming functions for one or more AC or DC power distribution lines. The inventive module is preferably sized to fit within existing outlet and switch boxes, while still leaving enough room for the conventional components that are also housed in such enclosures. Remote control is provided wirelessly—preferably using an existing wireless communication protocol. Local control is preferably also provided for the inventive switching module. Local control inputs preferably allow control via existing components—such as two-pole light switches.

### BRIEF DESCRIPTION OF THE SEVERAL VIEWS OF THE DRAWINGS

FIG. 1 is a schematic view, showing the general architecture of the inventive control module.

FIG. 2 is a schematic view, showing a preferred embodiment of a switch block.

FIG. 3 is a schematic view, showing a preferred embodiment of a power supply.

FIG. 4 is a perspective view, showing an exemplary physical package for the inventive control module.

FIG. 5 is a schematic view, showing the inventive control module being used to control a duplex receptacle.

FIG. 6 is a schematic view, showing the inventive control module being used to independently control two singe receptacles.

FIG. 7 is a schematic view, showing the inventive control module being used in conjunction with a single pole/single throw switch to control a load.

FIG. 8 is a schematic view, showing the inventive control module being used in conjunction with a pair of single pole/double throw switches to control a load.

FIG. 9 is a schematic view, showing the inventive control module being used in conjunction with a pair of single pole/single throw switches to control a load.

FIG. 10 is a schematic view, showing the use of a low voltage DC local control signal.

### REFERENCE NUMERALS IN THE DRAWINGS

10 control module
12 processor
14 power supply
16 switch block 1
18 switch block 2
antenna
22 jumper block
24 jumper
26 pin pair
28 TRIAC
30 opto-isolator
32 gate line
34 control line
36 differential amplifier
38 current line
40 amplifier
42 voltage line
44 rectifier
46 analog supply
48 digital supply
50 housing
52 cover
54 feed lines
55 latch
56 output lines
58 ground line
60 AC input lines
62 DC output lines
64 control lines
66 antenna line
68 enclosure
70 duplex receptacle
72 strap
74 2-conductor cable
76 line conductor
78 neutral conductor
80 wire nut
82 single receptacle
84 single receptacle
86 ground conductor
88 SPST switch
90 output pole
92 input pole
94 load
96 traveler
98 traveler
100 SPDT switch
102 common terminal
104 traveler terminal
106 DC line

### DETAILED DESCRIPTION OF THE INVENTION

The inventive switching module can be implemented in a wide variety of configurations. The following descriptions pertain to some specific embodiments. These descriptions should not be viewed as limiting, since the scope of the invention will be determined by the claims ultimately presented rather than the examples provided.

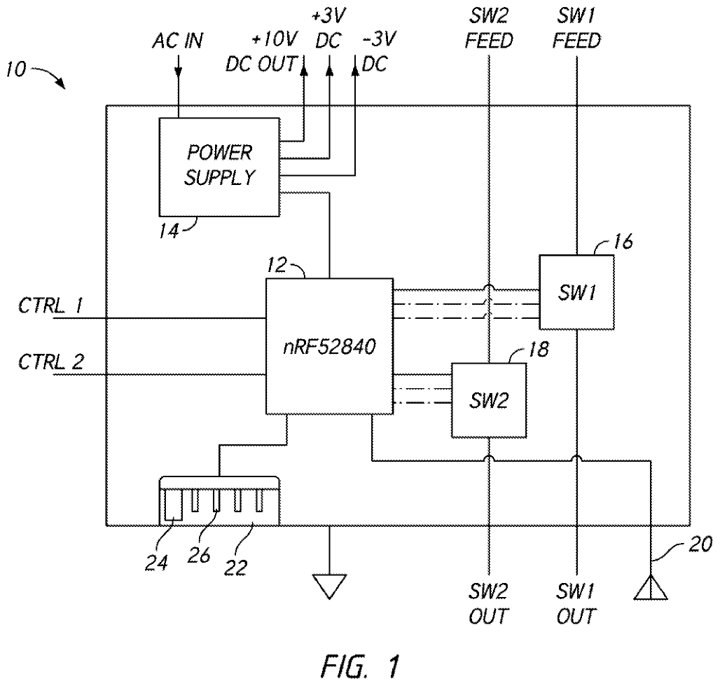

FIGS. 1-3 provide details of a preferred embodiment of the inventive switching module. A significant function of control module 10 is the switching of two lines. The switching is performed by a first switch block 16 (“SW1”) and a second switch block 18 (“SW2”). SW1 FEED leads into SW1. SW1 selectively connects SW1 FEED to SW1 OUT. This connection may be a simple binary state (on/off). However, the inventive control module is preferably capable of more sophisticated operations. An example is a pulse width modulated (“PWM”) output. The PWM output can be applied to provide dimmer functions on a light being controlled by the inventive module.

SW2 FEED leads into the second switch block—SW2. SW2 selectively connects SW2 FEED to SW2 OUT. As for SW1, SW2 can provide a simple binary state or a PWM output. The operation of the two switch blocks can be completely independent. They may also be ganged together if desired.

Power supply 14 receives external power via its AC input. It rectifies the AC input and generates regulated internal power for use within the control module. The power supply also preferably produces: (1) a 10V DC output line that can be switched as desired; (2) a +3 VDC output for use in control functions; and (3) a −3 VDC output for use in control functions.

Control of the inventive module is preferably carried out using a processor 12. In the example of FIG. 1, the processor is a nRF52840 made by Nordic Semiconductor of Trondheim, Norway. This particular processor includes advantageous internal radio frequency communication capability. It can, for example, communicate with other devices using the BLUETOOTH communication protocol. It also includes programmable internal memory allowing it to be customized for the performance of many tasks.

Processor 12 controls the functions of both switch blocks 16, 18. Processor 12 also receives information back from each of the switch blocks. The information preferably includes the present electrical current and voltage passing through each switch block. These values allow the processor to monitor the power being consumed by a load attached to SW1 OUT or SW2 OUT. The processor can store information regarding these values and periodically transmit this information to an external monitoring device.

Additional inputs and outputs are preferably provided for processor 12. Antenna 20 is provided to facilitate RF communication. Two control input lines (CTRL1 and CTRL2) are provided as well. These allow local control of the module, as will be explained subsequently.

Processor 12 can be programmed to operate in a number of different modes of operation. Various means can be used to access the various modes. As a first example, the current mode could be set via wireless communication from an external device (such as a tablet or smartphone). In the example of FIG. 1, however, jumper pins are used to set the mode of operation. A series of pin pairs 26 are provided within jumper block 22. A jumper 24 is placed across a particular pin pair to select a desired mode of operation.

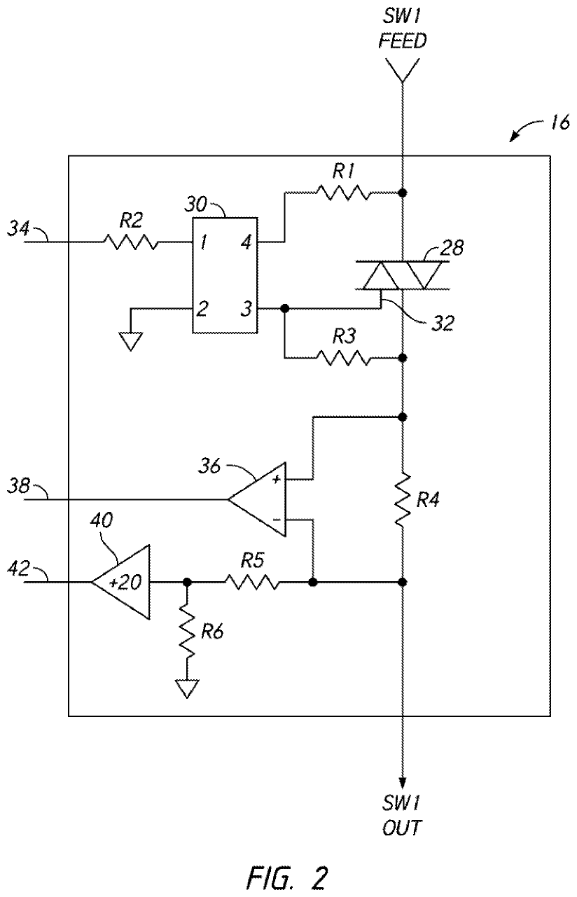

FIG. 2 shows some exemplary details of the switch blocks depicted in FIG. 1. This version of switch block 16 has two inputs and three outputs. SW1 FEED is the power line coming into the switch block. SW1 OUT is the switched line leaving the switch block. Control line 34 is the control input from processor 12 to switch block 16. Control line 34 carries a logic level control signal that controls the operation of the switch block. Current line 38 and voltage line 42 both provide information back to processor 12.

The main switching function is provided by TRIAC 28. “TRIAC” stands for “triode for alternating current.” A discussion of the function of these devices is beyond the scope of this disclosure, but those skilled in the art will know that they are well suited to the switching of alternating current. They can be cycled rapidly using a low-power control signal on gate line 32. Opto-coupler 30 is provided to isolate control line 34 from gate line 32 (a common practice). A low-power control signal provided by the processor on control line 34 is passed through opto-isolator 30 to gate line 32. The control signal then controls the amount of current passed through TRIAC 28.

TRIACs are of course known for switching AC power signals (since they can pass current in both directions). However, a TRIAC can also switch a DC power signal. The use of a TRIAC provides the flexibility of switching an AC signal in some applications and a DC signal in other applications. The TRIAC used is preferably rated at 800V and 25 A. This allows for current up to 20 A and voltage in the range of 10 VDC to 480 VAC.

In addition to simple on/off switching, a TRIAC in the configuration shown can cycle rapidly. This allows a pulse-width-modulated (“PWM”) output. The PWM output can be used to provide dimmer functions for a lighting load. It can also provide other load-control functions, such as controlling the speed of a motor. The switching and PWM functions can be provided for AC input signals and DC input signals, as will be explained.

Exemplary conventional circuit components are shown in the schematic, such as resistors R1, R2, and R3. These components are used to provide the proper operation of the opto-isolator and the TRIAC. The switch block preferably also includes output current and voltage measuring circuitry. The processor controls the operation of the switch block. It also receives information from the switch block. The information received preferably includes the switch block's output voltage and output current. This allows the processor to determine the amount of electrical power passing through the switch block and therefore the amount of power being consumed by a load connected to SW1 OUT.

Differential amplifier 36 measures the voltage drop across the resistor R4. According to Ohm's Law, this voltage drop is proportional to the current flowing through R4, which is the current flowing on SW1 OUT. The resistor R4 is of course selected to have a low resistance and a suitable current carrying capacity. The signal on current line 38 is a voltage signal that is proportional to the amount of current on SW1 OUT. Current line 38 is connected to an input on the processor. The processor reads this voltage and uses a first predetermined constant to calculate the current carried on SW1 OUT.

Resistor R5 connects the SW1 OUT line to amplifier 40. Resistor R6 connects a node between R5 and amplifier 40 to ground. Those skilled in the art will realize that a voltage present on voltage line 42 is proportional to the output voltage on SW1 OUT. Voltage line 42 is connected to an input of the processor. The processor reads this voltage and uses a second predetermined constant to calculate the output voltage on SW1 OUT. The processor preferably also calculates the power output for SW1 OUT (P=V*I).

Those skilled in the art will realize that the switching circuitry shown in FIG. 2 is one example among many possibilities. The invention is not limited to any particular type of switching circuit.

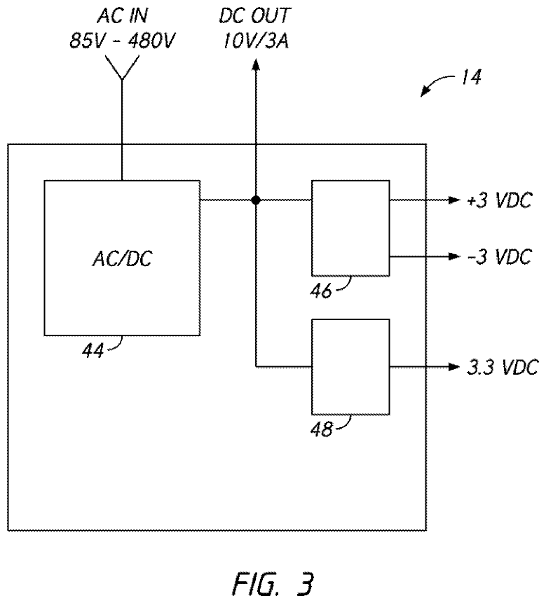

FIG. 3 shows some exemplary details of power supply 14. Power to operate the inventive module is ordinarily provided by the AC input to rectifier 44. The rectifier shown in this example can accept input power in the range of 85 VAC to 500 VAC. It can also accept various input frequencies, preferably in the range between 47 Hz and 63 Hz. Rectifier 44 produces a 10 VDC/3 A output. This output can be fed out to power DC devices (both switched an unswitched). The 10 VDC signal is also fed to analog supply 46, which produces +3 VDC and −3 VDC outputs. The rectifier feed is also used to power digital supply 48. Digital supply 48 produces a 3.3 VDC output that provides power for the processor and potentially other digital devices.

The power supply is also preferably able to accept an external DC input if no AC power is available. In that case an external DC supply voltage can be provided on the 10 VDC output line. This will eliminate the need for the rectifier and directly feed analog supply 46 and digital supply 48.

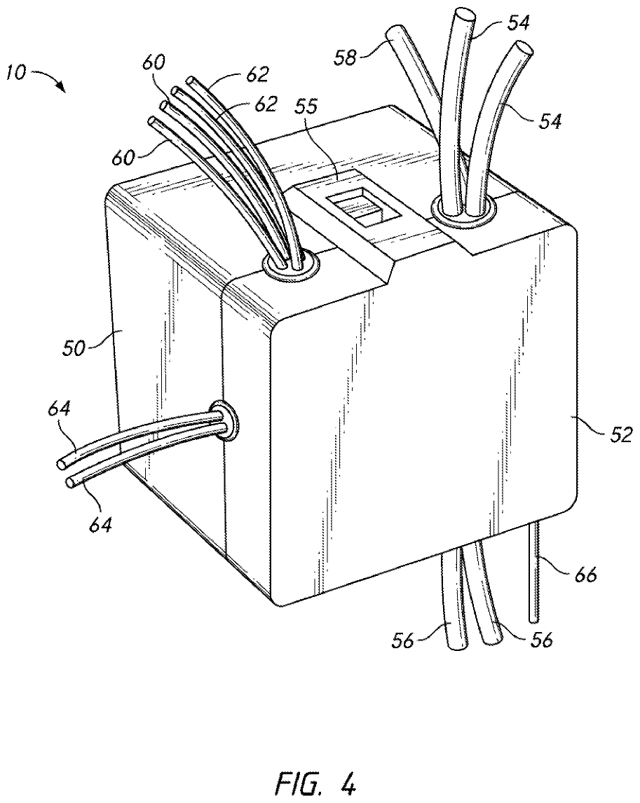

The inventive control module can be physically packaged in a wide variety of ways. One embodiment is a stand-alone package that is intended to be housed within existing switch boxes and receptacle enclosures such as are commonly used in residential and commercial electrical systems. For this application the physical packaging is preferably compact. FIG. 4 shows an exemplary embodiment configured for use within a switch box or receptacle enclosure. The packaging for this embodiment needs to be fairly compact, as the space within standard single-gang and two-gang electrical enclosures is limited. These enclosures are not strictly standardized. However, the exterior dimensions for standard residential electrical enclosures are generally as follows: For a single-gang enclosure—4.5 inches tall×2.75 inches wide×2 inches deep (11.4 cm×7.0 cm×5.1 cm). For a two-gang enclosure—4.5 inches tall×4.5 inches wide×2 inches deep (11.4 cm×11.4 cm×5.1 cm).

In order to fit within the available space, module 10 shown in FIG. 4 has a longest dimension that is preferably less than 1.50 inches (3.8 cm) and even more preferably less than 1.00 inches (2.5 cm). A first example of the module has dimensions of 1.50 inches×1.50 inches×1.50 inches (3.8 cm×3.8 cm×3.8 cm). A second example of the module has dimensions of 1.50 inches×1.0 inches×1.0 inches (3.8 cm×2.5 cm×2.5 cm). A third example of the module has dimensions of 1.00 inches×1.00 inches×1.00 inches (2.5 cm×2.5 cm×2.5 cm). Housing 50 contains the components schematically depicted in FIG. 1. Cover 52 attaches to the housing via a pair of snap latches 55 (only one of which is shown in FIG. 4).

In this example, the various input and output wires are captured between the housing and the lid. Suitable flexible grommets are provided to locate the wires and provide strain relief. A suitable length is provided for all the wires. A common method of connecting such wires is the use of wire nuts (Marrette connectors). These allow all connections to be made while the components are pulled out the front of an enclosure. The wire is then coiled and carefully urged back into the enclosure. A suitable length for the wires in this environment is 75 mm to 150 mm. A pre-stripped portion can also be provided on the end of each wire.

Not all physical packaging examples will include all the possible input and output wires. In this example, two feed lines 54 (SW1 FEED and SW2 FEED) and two output lines 56 (SW1 OUT and SW2 OUT) are included. A ground line 58 is also included to connect the device to the distribution system's ground line. AC input lines 60 provide power to the internal power supply. DC output lines 62 provide the 10 VDC/3 A output. Control lines 64 provide inputs for local control, as will be explained in the exemplary installations to follow. Antenna line 66 facilitates radio frequency communication with the processor within the control module. Additional DC output lines can be provided as well (+3 VDC and −3 VDC). These are not shown in the example of FIG. 4.

Field disassembly of the components of the inventive control module is unlikely. Thus, it can be advantageous to pot all the components into solid potting compound. In some versions the “housing” can just be a solidified block of potting compound. In other versions a thin housing can be used to contain the potting compound as it is introduced around the components and allowed to solidify.

Returning now to FIG. 1, some operation features of the preferred embodiments will be described. Processor 12 is equipped wit a communication link so that it can have one-way or two-way communications with an external computing device. The term external computing device means a smartphone, a tablet, a PC, a process controller, or other device containing a processor running software. The processor receives commands from the external computing device. The commands can be received using existing communications protocols—such as BLUETOOTH. In response to the receipt of such commands, processor 12 switches one or more of the switch blocks 16, 18 in order to control a load connected to SW1 OUT or SW2 OUT. The response control of a switch block can be to simply toggle it on or off. It can also be a more complex control function—such as transitioning one of the switch blocks from “on” to a PWM signal having a decreasing pulse width in order to gradually “fade” a light to off.

Processor 12 also monitors the electrical power on each output line, such as by monitoring line current and voltage. Processor 12 can use the communication link to transmit this obtained information to the external computing device. The transmission is preferably made wirelessly. Processor 12 preferably runs a controlling software program that can direct a variety of possible actions. For example, the processor can:

1. Periodically report a cumulative power consumption for loads attached to the output lines;

2. Report only when an “exceedance” is detected, such as a current spike;

3. Report regularly at defined intervals; and

4. Perform a “data dump” a few times each day in which the data is summarized and transmitted at a set time.

The two control input lines (CTRL1 and CTRL2) are provided so that a local control can furnish an input to the operation of control module 10. For example, the control module can be installed in an electrical enclosure housing a pair of residential light switches. In such an installation the inventive module provides wireless remote control of the lights. However, it is often also desirable to retain the local control provided by the light switches themselves. The two control input lines can be used to monitor the status of the light switches, as will be explained.

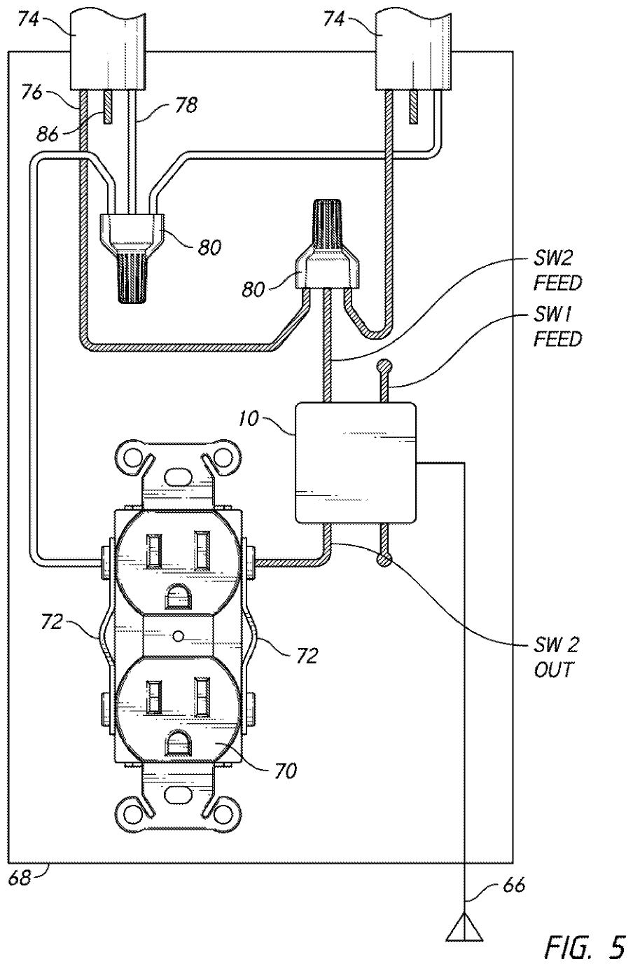

The inventive control module has many different applications. It is of course impossible to illustrate them all. FIGS. 5-10 provide a few exemplary applications. Those skilled in the art will appreciate that many, many more applications are possible.

FIG. 5 shows the use of control module 10 to control a duplex receptacle 70. A duplex receptacle has two receptacles ganged together—ordinarily by bridging the terminals for the two receptacles with a pair of conductive straps 72.

The duplex receptacle is contained within a conventional enclosure 68 (shown larger than its actual size). The enclosure is fed by a pair of two-conductor cables 74. Under the conventions established by the National Electrical Code of the United States, the term “two-conductor cable” means an insulated jacket in which three separate conductors are contained. The three separate conductors are known as the line conductor, the neutral conductor, and the ground conductor. The line and neutral conductors both have a separate insulting jacket. By convention, the line conductor is black and the neutral conductor is white.

In this example, the two-conductor cable 74 in the upper left travels to a breaker box. The two-conductor cable 74 in the upper right travels to additional receptacles fed by the same circuit. Connections are made using wire nuts 80. Neutral conductor 78 is connected to the neutral side of duplex receptacle 70 as is ordinarily done. The same wire nut also connects the neutral conductor to the rest of the parallel circuit—as is also conventional. However, line conductor 76 is not directly connected to the line side of duplex receptacle 70. Instead, the line conductor is connected to SW2 FEED on control module 10 (The selection of SW2 FEED instead of SW1 FEED is arbitrary in this example). The AC power connections to the control module are not shown for reasons of visual simplicity. However, it is a simple matter to add these connections to the wirenut-based connections already shown. Antenna line 66 is customarily passed out one of the bottom openings in enclosure 68. The antenna is allowed to dangle below the outlet block—typically behind the drywall.

The configuration shown in FIG. 5 provides a remote-controlled electrical receptacle. A remote device—such as smartphone, tablet, computer, or programmable logic controller, can be used to send a wireless signal to control module 10. Once the control module receives this signal it responds by switching on or off SW2 OUT, thereby switching on or off duplex receptacle 70.

Further, control module 10 can be used to monitor all electrical power passing through duplex receptacle 70. Even if no remote switching is desired, the monitoring and reporting functions can be significant.

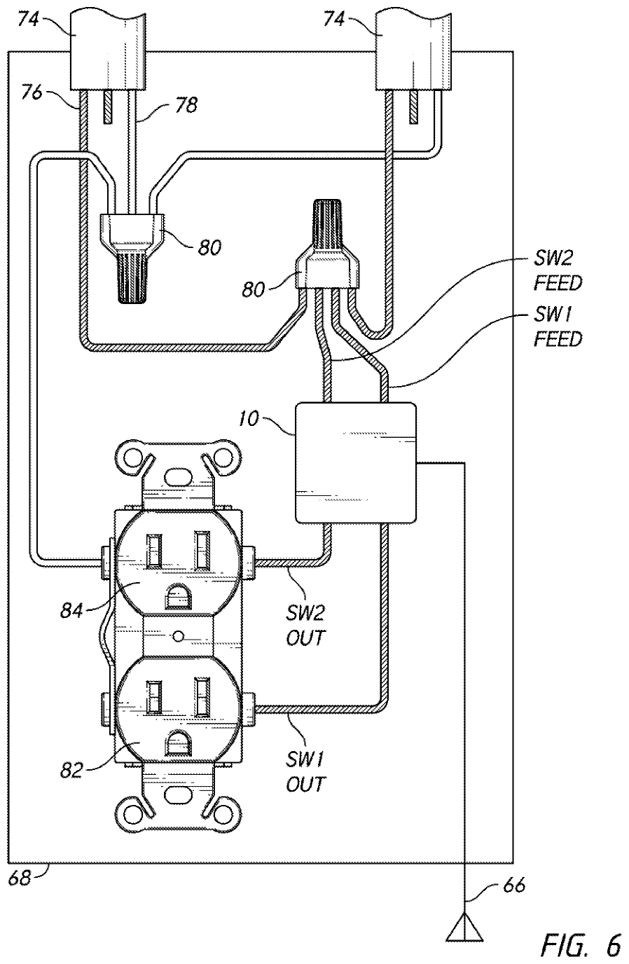

The configuration of FIG. 5 can be altered to independently switch the two receptacles in a duplex receptacle. It is usually possible to convert a duplex receptacle to two single receptacles by removing the strap 72 on the line side. This configuration is shown in FIG. 6. With the strap on the line side removed, the duplex receptacle becomes two single receptacles 82 that can be independently switched (The neutral side strap is left in place). SW2 OUT feeds power to the upper single receptacle 84, while SW1 OUT feeds power to the lower single receptacle 84. This configuration allows control module 10 to independently switch the two receptacles. In addition, this configuration allows independent monitoring of the power passed through each receptacle.

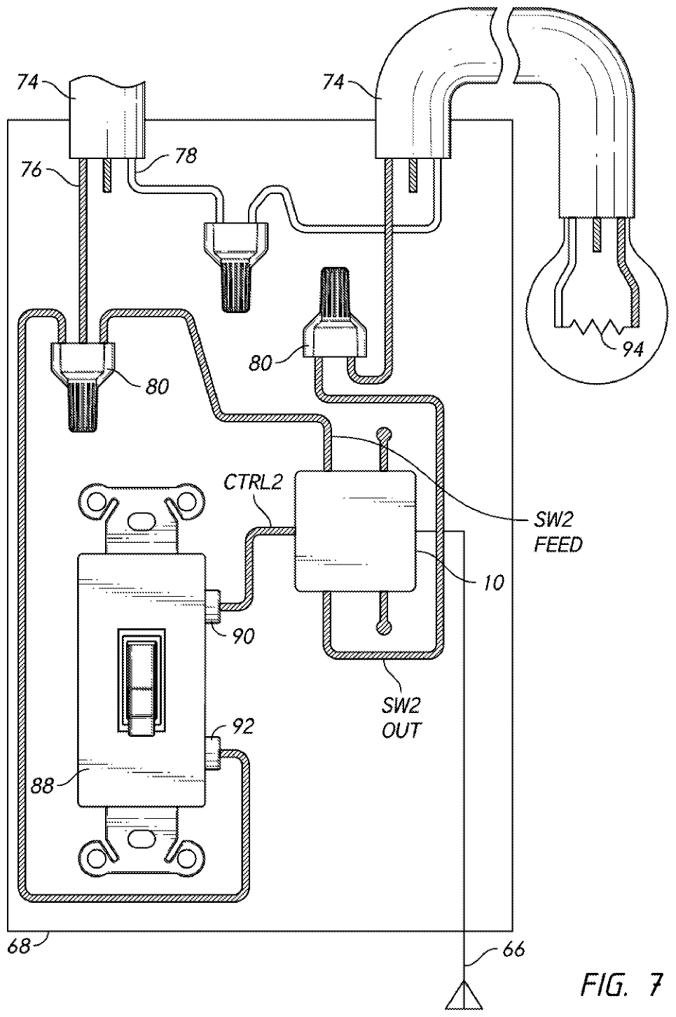

FIG. 7 shows an installation where control module 10 is used in conjunction with an existing single-pole/single-throw (“SPST”) switch. Line conductor 76 is connected to input pole 92 on the SPST switch. However, instead of connecting a conductor from output pole 90 to the load, the conductor from the output pole is connected to the CTRL 2 input on control module 10. In this embodiment the control line inputs for the inventive control module are configured to sense the presence of AC line voltage.

SW2 FEED is connected to the input line conductor 76. SW2 OUT us connected to load 94. The load's return path is through a neutral conductor 78 as usual. Control module 10 is configured to toggle load 94 on and off. If switch 88 is in the off position and an “on” command is given wirelessly to the control module, then the control module toggles on load 94 (and monitors power consumption as usual). If switch 88 is then flipped, control module 10 senses a change in the state of the input to CTRL2 and toggles load 94 off. Switch 88 is therefore no longer an on/off switch but acts like a switch in a “three-way” light circuit. That is, the switch no longer has a defined “on” position. Flipping the switch simply changes the state of the load irrespective of the starting position. The control module is configured to sense a change in the voltage state on CTRL 2, and when such a change is detected the control module toggles the state of the load.

Of course, the programming for the control module can be more sophisticated than a simple toggle function. The R/F command sent can change the input from the SPST switch 88 to be a conventional on/off switch or a toggle-function switch.

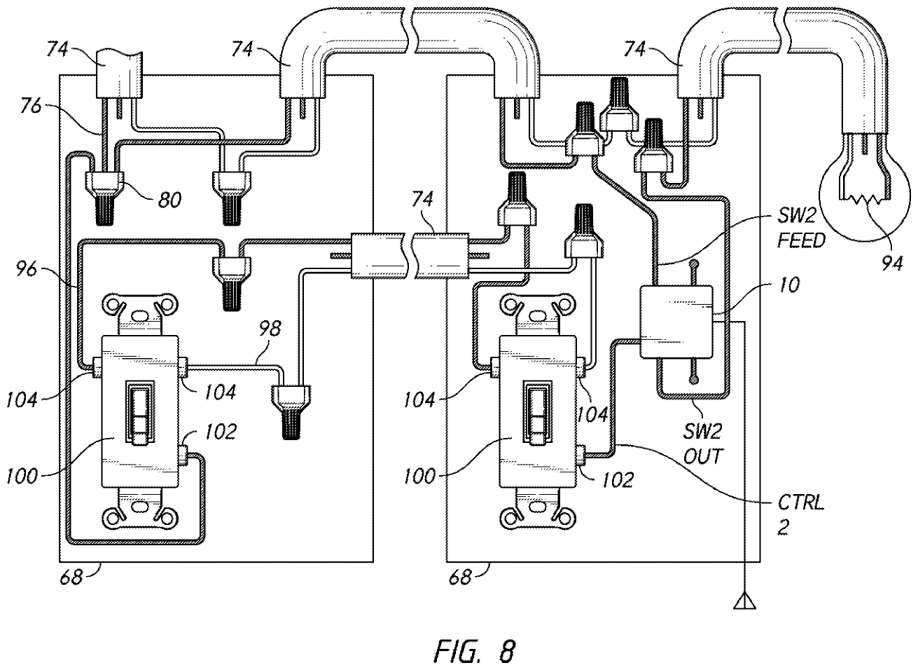

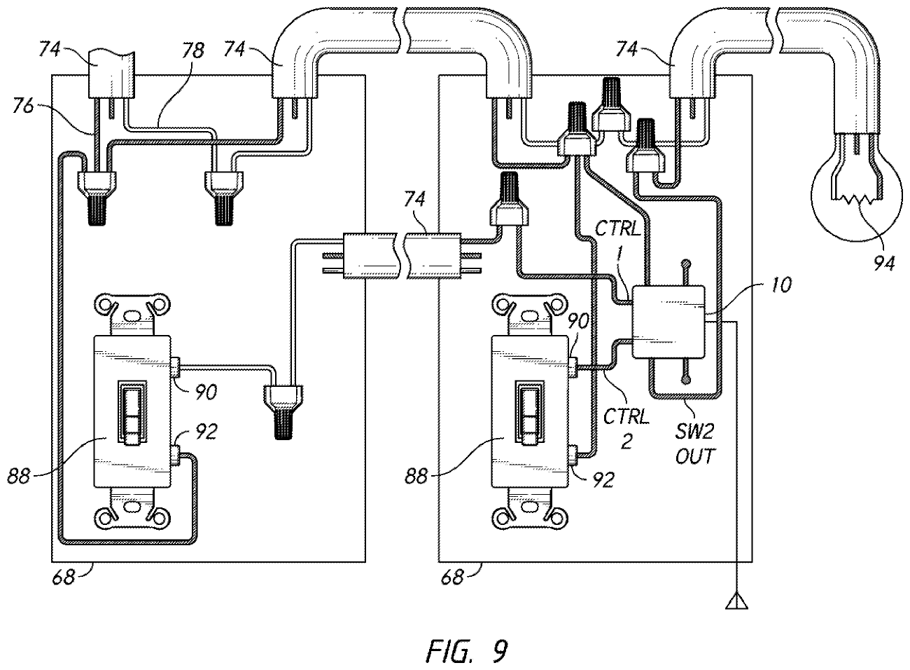

FIGS. 8 and 9 show the use of the inventive control module in three-way load circuits. Such circuits are typically used for the control of lighting. A “three-way circuit” allows two separate light switches to control a light (or other load). The switches no longer have a fixed on or off position, but instead operate to toggle the status of the load. The term “three-way” results from the fact that a “three-way switch” is used—meaning a switch with three poles. A more precise term for such a switch is a single-pole/double-throw (“SPDT”) switch.

FIG. 8 shows a conventional arrangement for a three-way lighting circuit. Those skilled in the art will know that multiple configurations exist. FIG. 8 shows a modification of the configuration specified in the United States National Electrical Code. Two enclosures 68 are present—each of which houses a SPDT switch 100. A two-conductor cable 74 (shown in the upper left of the view) feeds power from the breaker box into the left enclosure 68. A second two-conductor cable 74 (shown near the top of the view) connects the two enclosures. A third two-conductor cable 74 (in the upper right of the view) connects load 94.

Each SPDT switch 100 has a common terminal 102 and two traveler terminals 104. Flipping the switch alternatively connects each traveler terminal to the common terminal. Line conductor 76 is connected to the common terminal 102 of the left SPDT switch 100. The left traveler terminal of the left SPDT switch 100 is connected to the left traveler terminal of the right SPDT switch 100. Likewise, the right traveler terminal of the left SPDT switch 100 is connected to the right traveler terminal of the right SPDT switch 100. Those skilled in the art will know that three-way light circuits can be wired in other ways—such as via the use of a three-conductor or four-conductor cable.

In the configuration of FIG. 8, common terminal 102 on the right SPDT switch 100 is connected to the CTRL 2 input on control module 10. Flipping either SPDT switch 100 at any time will cause a change in state on the input to CTRL 2 (either changing from no-voltage to voltage, or from voltage to no-voltage). In response, control module 10 toggles the state of load 94.

This describes the operation of a conventional three-way circuit. But, in addition, control module 10 can also be switched by the receipt of an external wireless signal. The receipt of such a signal will also cause control module 10 to toggle the state of load 94. Thus, in the configuration of FIG. 8, the status of load 94 can be toggled by (1) flipping the left SPDT switch, (2) flipping the right SPDT switch, or (3) sending a wireless command to control module 10. In any case, the power monitoring functions of control module 10 continue.

FIG. 9 shows another possible configuration for a three-way load circuit using the inventive module. This version uses single-pole/single-throw switches 88 (which would not ordinarily be used in a three-way circuit). Line conductor 76 is connected to input pole 92 on the left SPST switch 88. Output pole 90 on the left SPST switch is connected to the CTRL 1 input on control module 10 in the right-hand enclosure 68.

Line conductor 76 is likewise connected to input pole 92 on the right SPST switch 88. Output pole 90 on the right SPST switch is connected to the CTRL 2 input on control module 10. Flipping the left switch 88 to “on” places AC voltage on CTRL 1. Flipping the right switch 88 to “on” places AC voltage on CTRL 2. Control module 10 is programmed to interpret a change of state on either CTRL 1 or CTRL 2 as a command to toggle the state of load 94. In addition, control module 10 is programmed to interpret an external wireless input as a command to toggle the state of load 94. The power monitoring functions of control module 10 are present as well.

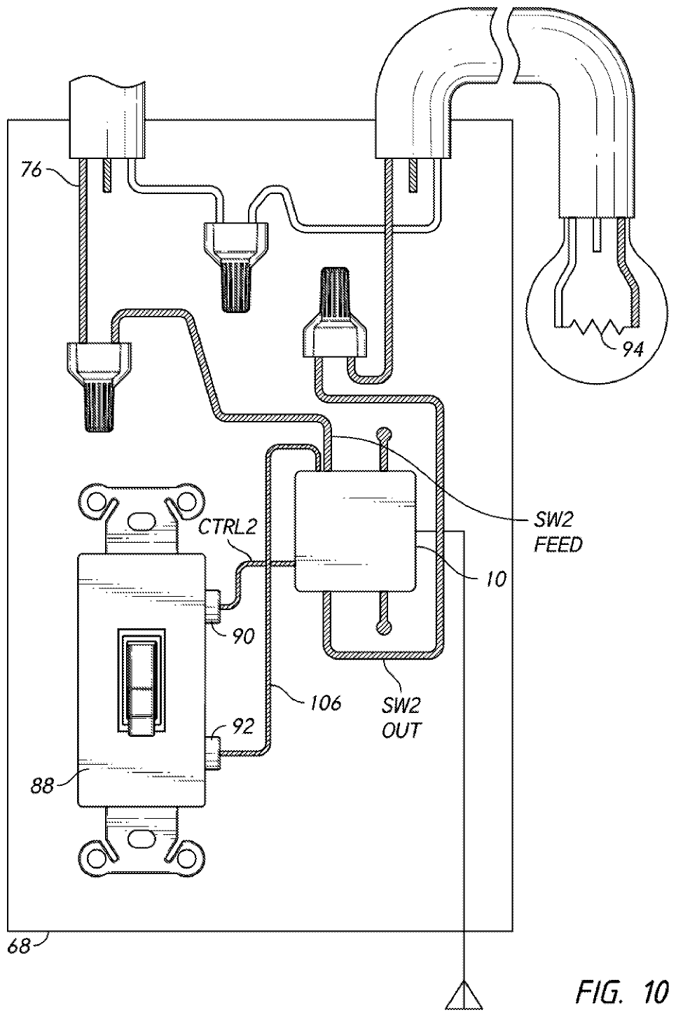

FIG. 10 shows still another operational configuration for the inventive control module. Returning briefly to FIG. 1, the reader will recall that power supply has three DC outputs. One of these is a +3 VDC line. Looking now at FIG. 10, this +3 VDC signal is fed via DC line 106 to input pole 92 on SPST switch 88. Output pole 90 on the same switch is fed to the CTRL 2 input on control module 10. In this embodiment of the control module, the input lines CTRL 1 and CTRL 2 are configured to detect low voltage DC signals. When SPST switch 88 is turned on, +3 VDC is applied to CTRL 2. Control module 10 is programmed in this embodiment to interpret a change on CTRL 2 as a command to toggle the state of load 94. An external wireless input will also cause control module 10 to toggle the state of load 94.

Another scenario involves the substitution of a dimmer switch for the SPST switch 88 shown in FIG. 10. A common variety of dimmer switches allows a user to push the switch to toggle it on or off. While in the “on” state, the user rotates the knob to set a desired level of brightness. Such a dimmer switch can be wired in the same way as the SPST switch shown in FIG. 10 is wired. Control module 10 senses a desired dimming state by measuring the input voltage on CTRL 2. A value less than 3.3 VDC will indicate a desired level of dimming. The control module then adjusts the duty cycle on the PWM output for SW2 OUT.

Some embodiments of the inventive control module can be configured to sense line AC voltages on CTRL 1 and CTRL2, while other embodiments can be configured to sense lower voltages. It is possible to create sensing circuitry that is suitable for either, but such circuitry adds expense and complexity. For example, the processor itself will often have I/O ports that can directly sense the presence of a +3 VDC signal on one of the control lines. One would not of course directly connect 110 VAC to the same I/O port. Instead, a high-impedance sensing circuit would likely be provided.

Looking again at FIG. 1, the reader will recall the presence of a 10 VDC/3 A output line from power supply 14. If a remote-controlled DC output is desired, one can jumper this output line to SW1 FEED, SW2 FEED, or both. Processor 12 can then control the switch blocks 16, 18 to produce a switched DC output on SW1 OUT and SW2 OUT. Such an output can be used to control LED lighting, landscape lighting, sprinkler systems, automatic gates, and similar items.

The invention can be operated in many additional configurations. As an example, the inventive control module can function as a remotely controllable 3-phase switch. In this application the switch blocks are used to switch two of the three phases.

In the preferred embodiments the operating mode will be set when the inventive control module is installed. An example of this is shown in FIG. 1, where the position of an electrical jumper 24 is used to select the operating mode. The following table illustrates some selectable modes of operation:

| MODE | CONTROL | USE |
|---|---|---|
| 1 | RF only | duplex receptacle - both switched together |
| 2 | RF only | receptacle - each switched independently |
| 3 | RF and local | single 2-way switch |
| 4 | RF and local | dual 2-way switch - operated independently |
| 5 | RF and local | single 2-way with dimmer |
| 6 | RF and local | dual 2-way with dimmer |
| 7 | RF and local | single 2-way switch and single 2-way dimmer |
| 8 | RF and local | single 3-way switch |
| 9 | RF and local | single 3-way dimmer |
| 10 | RF and local | single 3-phase mode |

Numerous other features can be provided alone or in combination. These features include, without limitation.

1. Wireless communication protocols other than BLUETOOTH, such as ZIGBEE or THREAD;

2. Additional local control inputs beyond the two provided;

3. Additional switched lines beyond the two provided;

4. An internal battery to preserve logic functions in the event of a power interruption;

5. The ability to set a desired operating mode via RF communication with the processor;

6. The provision of software running on an external device that communicates with the inventive control module in order to monitor the power consumption of devices being fed by SW1 OUT and SW2 OUT;

7. The provision of software running on an external device that provides a user interface for operating and monitoring the inventive control module(s);

8. The provision of software running on an external device that provides a user interface for aggregating information from multiple inventive control modules; and

9. The use of existing external devices (such as ALEXA) to control the inventive control module and receive information from the inventive control module.

Although the preceding descriptions contain significant detail, they should not be construed as limiting the scope of the invention but rather as providing illustrations of the preferred embodiments of the invention. Those skilled in the art will know that many other variations are possible without departing from the scope of the invention. Accordingly, the scope of the invention should properly be determined with respect to the claims that follow rather than the examples given.

Having described our invention, we claim:

1. A control module configured to fit within a single-gang electrical enclosure, said control module being configured to communicate with an external computing device, comprising:
(a) a processor having an associated memory, with said processor being configured to run software stored in said associated memory;
(b) a communication link connecting said processor with said external computing device;
(c) a first switch feed line;
(d) a first switch output line;
(e) a first switch block configured to regulate a flow of electrical current between said first switch feed line and said first switch output line;
(f) said first switch block being controlled by said processor;
(g) a first control line; and
(h) wherein said processor is configured to alter a flow of electrical current through said first switch block in response to a signal received over said communication link and in response to a signal received over said first control line.

2. The control module as recited in claim 1, further comprising:
(a) a second switch feed line;
(b) a second switch output line;
(c) a second switch block configured to regulate a flow of electrical current between said second switch feed line and said second switch output line;
(d) said second switch block being controlled by said processor;
(e) a second control line; and
(f) wherein said processor is configured to alter a flow of electrical current through said second switch block in response to a signal received over said communication link and in response to a signal received over said second control line.

3. The control module as recited in claim 1, wherein said first switch block is configured to rapidly vary said flow of electrical current through said first switch block.

4. The control module as recited in claim 1, wherein said control module is configured to measure a value corresponding to electrical power on said first switch output line.

5. The control module as recited in claim 4, wherein said control module is configured to store said measured electrical power in said memory.

6. The control module as recited in claim 4, wherein said control module is configured to transmit said measured electrical power over said communication link to said external computing device.

7. The control module as recited in claim 2, wherein said control module is configured to transmit said measured electrical power for said first switch output line and transit a second measured electrical power for said second switch output line over said communication link to said external computing device.

8. A control module configured to fit within a standard residential electrical enclosure, said control module being configured to communicate with an external computing device, comprising:
(a) a processor having an associated memory;
(b) a wireless communication link connecting said processor with said external computing device;
(c) a first switch feed line;
(d) a first switch output line;
(e) a first switch block configured to regulate a flow of electrical current between said first switch feed line and said first switch output line;
(f) said first switch block being controlled by said processor;
(g) a first control line; and
(h) wherein said processor is configured to alter a flow of electrical current through said first switch block in response to a signal received over said communication link and in response to a signal received over said first control line.

9. The control module as recited in claim 8, further comprising:
(a) a second switch feed line;
(b) a second switch output line;
(c) a second switch block configured to regulate a flow of electrical current between said second switch feed line and said second switch output line;
(d) said second switch block being controlled by said processor;
(e) a second control line; and
(f) wherein said processor is configured to alter a flow of electrical current through said second switch block in response to a signal received over said communication link and in response to a signal received over said second control line.

10. The control module as recited in claim 8, wherein said first switch block is configured to rapidly vary said flow of electrical current through said first switch block.

11. The control module as recited in claim 8, wherein said control module is configured to measure a value corresponding to electrical power on said first switch output line.

12. The control module as recited in claim 11, wherein said control module is configured to store said measured electrical power in said memory.

13. The control module as recited in claim 11, wherein said control module is configured to transmit said measured electrical power over said communication link to said external computing device.

14. The control module as recited in claim 9, wherein said control module is configured to transmit said measured electrical power for said first switch output line and transit a second measured electrical power for said second switch output line over said communication link to said external computing device.

15. A control module configured to fit within a standard residential electrical enclosure, said control module being configured to communicate with an external computing device, comprising:
(a) a processor having an associated memory, with said processor being configured to run software stored in said associated memory;
(b) a wireless communication link connecting said processor with said external computing device, said link providing two-way communication;
(c) a first switch feed line;
(d) a first switch output line;
(e) a first switch block configured to regulate a flow of electrical current between said first switch feed line and said first switch output line;
(f) said first switch block being controlled by said processor;
(g) a first control line; and
(h) wherein said processor is configured to alter a flow of electrical current through said first switch block in response to a signal received over said communication link and in response to a signal received over said first control line.

16. The control module as recited in claim 15, further comprising:
(a) a second switch feed line;
(b) a second switch output line;
(c) a second switch block configured to regulate a flow of electrical current between said second switch feed line and said second switch output line;
(d) said second switch block being controlled by said processor;
(e) a second control line; and
(f) wherein said processor is configured to alter a flow of electrical current through said second switch block in response to a signal received over said communication link and in response to a signal received over said second control line.

17. The control module as recited in claim 15, wherein said first switch block is configured to rapidly vary said flow of electrical current through said first switch block.

18. The control module as recited in claim 15, wherein said control module is configured to measure a value corresponding to electrical power on said first switch output line.

19. The control module as recited in claim 18, wherein said control module is configured to store said measured electrical power in said memory.

20. The control module as recited in claim 18, wherein said control module is configured to transmit said measured electrical power over said communication link to said external computing device.
